(19) United States
(12) Patent Application Publication
(10) Pub. No.: US 2005/0102540 A1
(43) Pub. Date: May 12, 2005

(54) Computer system and control method thereof

(75) Inventors: In-soo Kim, Seoul (KR); Jae-seong Im, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/979,115

(22) Filed: Nov. 3, 2004

(30) Foreign Application Priority Data
Nov. 10, 2003 (KR) 2003-78957

(51) Int. Cl. G06F 1/26

(52) U.S. Cl. 713/300

(57) ABSTRACT

A computer system and control method thereof performing a power off mode if the computer system performs a predetermined power mode when the computer system is unstable. A power button activates a predetermined power mode; an operating system recognizes an input signal of the power button to generate a signal and determine whether to terminate an application currently being performed and whether to supply power to each of inner and outer devices of the system depending on the predetermined power mode. A system operation power mode detector detects an operational state of the system and a controller controls the operating system to generate a signal corresponding to a power-off mode to reboot the system if the system operation detector detects that the system is unstable when the power mode is not set to the power-off mode.

### CROSS-REFERENCE TO RELATED APPLICATIONS

This application claims the benefit of Korean Patent Application No. 2003-78957, filed on Nov. 10, 2003, in the Korean Intellectual Property Office, the disclosure of which is incorporated herein by reference.

### BACKGROUND OF THE INVENTION

1. Field of the Invention

The present invention relates to a computer system and control method thereof, and more particularly, to a computer system activating a power-off mode if a predetermined power mode is performed when the system is unstable.

2. Description of the Related Art

In general, a computer system comprises power management modes such as a stand-by mode, a power saving mode, a power off mode, etc. The stand-by mode cuts off power supplied to a monitor and a hard disk drive which consume the most power to reduce power consumption. The power saving mode cuts off the power supplied to the monitor and the hard disk drive similar to the stand-by mode, cuts off the power supplied to peripheral devices, and supplies the power to a random access memory (RAM) only. Accordingly, data currently being processed is saved in the RAM.

For example, if the system is running a Windows operating system (OS), a user may set a power mode of the system to the stand-by mode, the power saving mode or the power off mode. If the user sets the power mode to the power off mode, the system is shut down as a power button signal is input. Further if the power mode is set to the stand-by mode, the system is switched to the stand-by mode as the power button signal is input. Accordingly, the power supplied to the monitor and the hard disk drive is cut off. Here, if a keyboard or pointing device signal is input, the system returns to a previous state.

If a predetermined power mode is not set to the power-off mode but is set to the stand-by mode or the power saving mode and the power button signal is inputted, the system is rebooted faster than when rebooting under the power off mode because the system is not shut down under the stand-by mode or the power saving mode. However, the system slows down or experiences a failure of rebooting because the OS does not properly process applications or drivers if the system is frequently rebooted under the stand-by mode or the power saving mode.

### SUMMARY OF THE INVENTION

Accordingly, it is an aspect of the present invention to provide a computer system and control method thereof performing a power off mode if the computer system performs a predetermined power mode when the computer system is unstable.

The foregoing and/or other aspects of the present invention are also achieved by providing a computer system comprising a power button activating a predetermined power mode; an operating system generating a signal determining whether to terminate an application currently being performed and whether to supply power to each of inner and outer devices of the system depending on the predetermined power mode when the OS recognizes an input signal of the power button; a system operation detector detecting operational state of the system; and a controller controlling the OS to generate a signal corresponding to a power-off mode to reboot the system if the system operation detector detects that the system is unstable when the power mode is not set to the power-off mode.

According to an embodiment of the invention, the computer system further comprises a message storage storing a rebooting alarm message advising that the system is shut down by instability of the system; and a display displaying a picture thereon, wherein the controller controls the message storage to store the rebooting alarm message when the power mode is not set to the power-off mode if the controller controls to reboot the system due to instability of the system, the OS displaying the rebooting alarm message on the display if the rebooting alarm message is stored in the message storage when the system is rebooted.

According to an embodiment of the invention, the system operation detector further comprises a counter, wherein the counter counts how many times the predetermined power mode is performed by the input signal of the power button when the power mode is not set to the power-off mode, and the controller controls the OS to generate the signal corresponding to the power-off mode to reboot the system when the counter counts that the predetermined power mode is performed more than a predetermined number of times.

According to an embodiment of the invention, the system operation detector further comprises an application counter, wherein the application counter counts applications currently being performed when the power mode is not set to the power-off mode, and the controller controls the OS to generate the signal corresponding to the power-off mode to reboot the system when the application counter counts that the applications currently being performed are more than a predetermined number.

The foregoing and/or other aspects of the present invention are also achieved by providing a method of controlling the computer system, the method comprising setting a power mode; generating an input signal to perform the set power mode; detecting whether the power mode is set to a power-off mode rebooting the system; detecting an operational state of the system when the power mode is not set to the power-off mode; generating a signal corresponding to the power off mode if the operational state of the system is detected as unstable; and rebooting the system according to the corresponding signal.

According to an embodiment of the invention, the method further comprises displaying a rebooting alarm message when the system is rebooted according to the corresponding signal, advising that the system is shut down due to instability of the system.

According to an embodiment of the invention, the system is detected to be unstable when the power mode is not set to the power-off mode and the set power mode is performed more than a predetermined number of times.

According to an embodiment of the invention, the system is detected to be unstable when the power mode is not set to the power-off mode and the number of applications that are currently being performed exceeds a predetermined number.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a control block diagram of a computer system according to an embodiment of the present invention;

FIG. 2 is a control diagram of an OS shown in FIG. 1;

FIG. 3 is a rebooting message displayed on a display shown in FIG. 1; and

FIG. 4 is a control flow of the computer system shown in FIG. 1.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

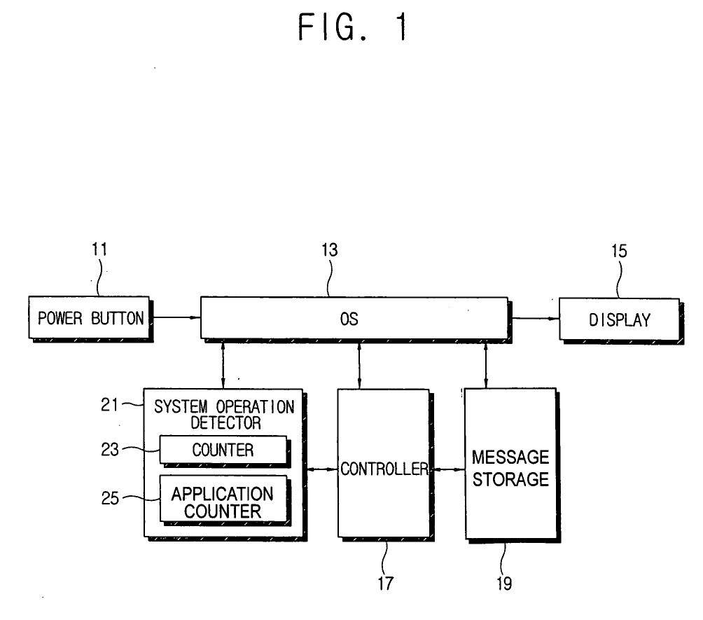

As shown in FIG. 1, a computer system according to an embodiment of the present invention, comprises a power button 11; an operating system (OS) 13; a controller 17; a message storage 19 storing a rebooting message advising that the computer system is shut down by instability of the system; a system operation detector 21 checking an operational status of the system; and a display 15 displaying an image thereon.

The power button 11 activates the system to perform according to a predetermined power mode. The power button 11 is provided in a main body of the system or provided as a combination of hot keys in a keyboard. An input signal of the power button 11 is directly generated by a user, or automatically generated if the system satisfies a certain condition.

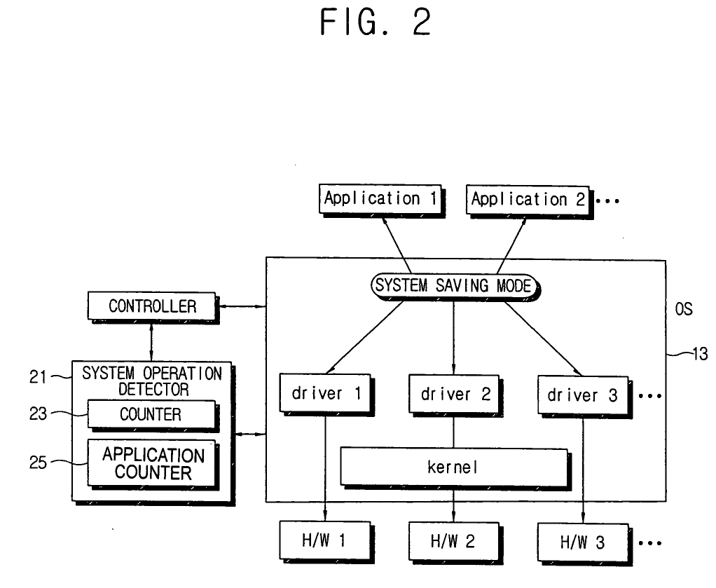

The OS 13 detects the input signal of the power button 11 and generates a signal to determine whether to terminate an application currently being performed and whether to supply power to each of inner and outer devices (FIG. 2, H/W 1, H/W 2, H/W 3) of the system depending on the predetermined power mode.

The system operation detector 21 comprises at least one of an counter 23 or an application counter 25. The counter 23 counts how many times the predetermined power mode is performed by the input signal of the power button 11 when the predetermined power mode is not set to the power-off mode shutting down the system. The application counter 25 counts how many applications are currently being performed when the power mode is not set to the power-off mode.

The controller 17 controls the OS 13 to generate the signal corresponding to the power-off mode to reboot the system if the system operation detector 21 detects that the system is unstable and the predetermined power mode is not set to the power-odd mode. Herein, the controller 17 controls the message storage 19 to store the rebooting alarm message. After the system is rebooted, the rebooting alarm message stored in the message storage 19 is popped up on the display 15.

The system may become unstable and if the predetermined power mode is performed by the input signal of the power button 11 more than a predetermined number of times, or more than a predetermined number of applications are currently being performed, when the predetermined power mode is not set to the power-off mode.

The controller 17 controls the OS 13 to generate a signal corresponding to the power-off mode to reboot the system when the counter 23 counts that the predetermined power mode is performed more than the predetermined number of times, or the application counter 25 counts that more than the predetermined number of applications are currently being performed.

As shown in FIG. 2, if the power mode is predetermined and the input signal is inputted to perform the predetermined power mode by the power button 11, the OS 13 recognizes the input signal of the power button 11 and generates a signal to determine whether to terminate the applications currently being performed and whether to supply power to each of inner and outer devices (H/W 1, H/W 2, H/W 3) of the system depending on the predetermined power mode.

The applications currently being performed and each of the drivers driving the inner and outer devices receive the signal generated by the OS 13 and determine whether to terminate the applications and whether to supply the power to the respective devices.

For example, if the power mode is predetermined to the power-off mode and the power button 11 generates the input signal, the OS 13 receives the input signal from the power button 11 and generates the signal to shut down the system. Herein, the input signal from the power button 11 may be automatically generated if the system is idled for a certain period of time. Thus, the applications currently being performed are terminated and each of the drivers cuts off the power for the inner and outer devices (H/W 1, H/W 2, H/W 3) according to the signal generated by the OS 13.

If the power mode is predetermined as the power saving mode and the input signal of the power button 11 is generated, the OS 13 generates a signal to perform the power saving mode. Here, the applications currently being performed and related data are saved to the RAM, together with a current desktop as an image file format. Each of the drivers received the signal from the OS 13 supplies the power to the RAM only, and cuts off the power to the monitor, the hard disk drive and other peripheral devices. Thus, if the power is on later, the system performs the exact same applications and related data in the same desktop that the system was performing before entering the power saving mode. Further, if the power mode is predetermined as a stand-by mode and the input signal of the power button 11 is generated, the OS 13 generates the signal to perform the stand-by mode. Here, each of the drivers cuts off the power supplied to the monitor and the hard disk drive which consume the most power the to reduce the power consumption.

However, if the system operation detector 21 detects that the system is unstable when the power mode is not set to the power-off mode, the controller 17 controls the OS 13 to generate the signal to shut down the system when the input signal of the power button 11 is generated to perform the predetermined power mode.

For example, where the power mode is predetermined to be the power saving mode and the input signal of the power button 11 is generated, the counter 23 counts how many times the power saving mode is performed. Here, if the counted number exceeds a predetermined number of times, the controller 17 ignores the signal generated by the OS 13 for the power saving mode, and accordingly the system does not enter the power saving mode. Here, if the OS 13 broadcasts the signal to shut down the system, each of the applications (e.g., application 1 and application 2) and the device drivers (e.g., driver 1, driver 2, driver 3) receive the signal. Accordingly, the system is shut down and rebooted.

Here, the controller 17 stores the rebooting alarm message advising that the system is shut down by instability of the system to the message storage 19. If the message is stored in the message storage 19, the OS 13 displays the rebooting alarm message on the display 15 when the system is rebooted.

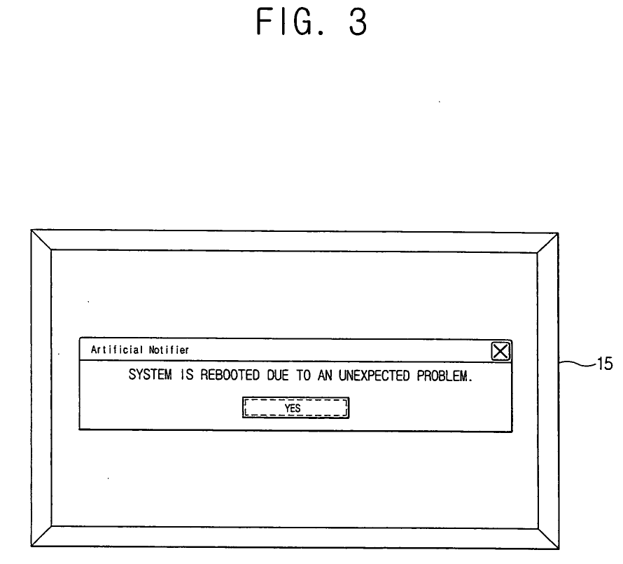

As shown in FIG. 3, as a result of displaying the rebooting alarm message on the display 15 advising that the system is rebooted after shutting down in order to protect the system, the system obtains credibility from the user.

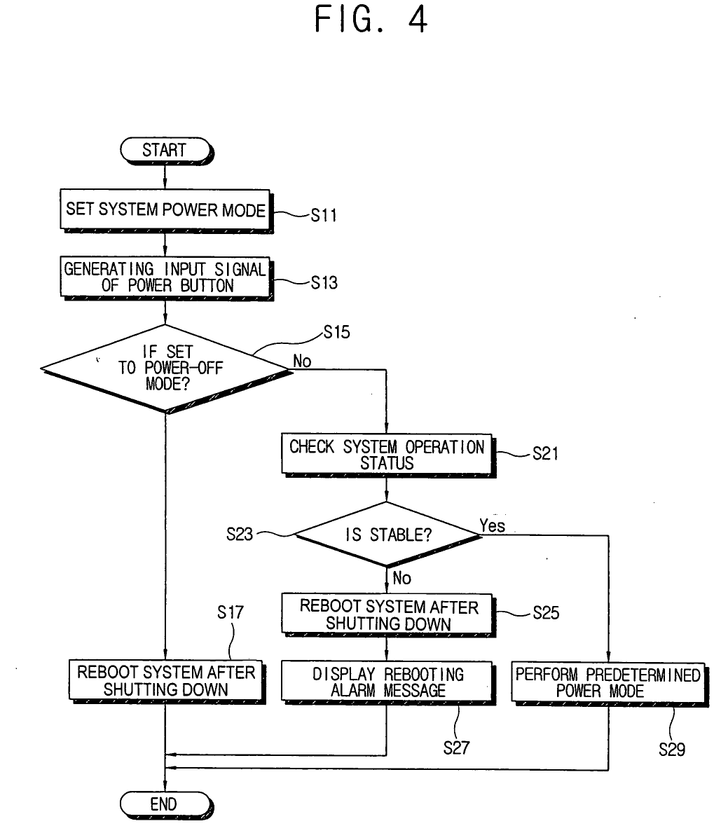

A flow chart of the computer system according to an embodiment of the present invention is shown in FIG. 4.

At first, the user sets the power mode to the power-off mode, the stand-by mode or the power saving mode at operation S11. Then, the input signal of the power button 11 is generated to perform the predetermined power mode at operation S13, and the OS 13 determines to which power mode the system is set, at operation S15.

Here, if the system is set to the power-off mode, the OS 13 shuts down and reboots the system, at operation S17. However, if the power mode is not set to the power-off mode but set to the stand-by mode or the power saving mode, the system operation detector 21 detects stability of the system at operation 21.

If the system detector 21 confirms that the system is stable at operation S23, the OS 13 performs the predetermined power mode at operation S29. However, if the system detector 21 detects that the system is unstable at operation S23, the controller 17 controls the OS 13 to shut down the system and thus the system is rebooted at operation S25. For example, the input signal of the power button 11 is generated when the power mode is set to the stand-by mode. If the counter 23 counts that the stand-by mode is performed more than the predetermined number of times, the controller 17 controls the OS 13 to shut down the system.

Moreover, the display 15 displays the rebooting alarm message advising that the system is shut down by instability of the system, at operation S27, thereby obtaining the credibility from the user.

As described above, according to embodiments of the present invention, it is provided a computer system and control method thereof performing a power off mode if the computer system performs a predetermined power mode when the computer system is unstable.

Although a few embodiments of the present invention have been shown and described, it would be appreciated by those skilled in the art that changes may be made in these embodiments without departing from the principles and spirit of the invention, the scope of which is defined in the claims and their equivalents.

1. A computer system comprising:
a power button activating a predetermined power mode;
an operating system (OS) generating a signal determining whether to terminate an application currently being performed and whether to supply power to each of inner and outer devices of the system depending on the predetermined power mode when the OS recognizes an input signal of the power button;
a system operation detector detecting an operational state of the system; and
a controller controlling the OS to generate a signal corresponding to a power-off mode to reboot the system if the system operation detector detects that the system is unstable when the power mode is not set to the power-off mode.

2. The computer system according to claim 1, further comprising:
a message storage storing a rebooting alarm message advising that the system is shut down by instability of the system; and
a display displaying an image thereon, wherein:
the controller controls the message storage to store the rebooting alarm message when the power mode is not set to the power-off mode if the controller controls to reboot the system due to the instability of the system, and
the OS displays the rebooting alarm message on the display if the rebooting alarm message is stored in the message storage when the system is rebooted.

3. The computer system according to claim 1, wherein the system operation detector further comprises a counter, wherein:
the counter counts how many times the predetermined power mode is performed by the input signal of the power button when the power mode is not set to the power-off mode, and
the controller controls the OS to generate the signal corresponding to the power-off mode to reboot the system when the counter counts that the predetermined power mode is performed more than a predetermined number of times.

4. The computer system according to claim 1, wherein the system operation detector further comprises an application counter, wherein:
the application counter counts applications currently being performed when the power mode is not set to the power-off mode, and
the controller controls the OS to generate the signal corresponding to the power-off mode to reboot the system when the application counter counts that the applications currently being performed are more than a predetermined number.

5. A method of controlling the computer system, comprising:
setting a power mode;
detecting whether the power mode is set to a power-off mode rebooting the system;
detecting an operational state of the system when the power mode is not set to the power-off mode;
generating a signal corresponding to the power off mode if the operational state of the system is detected as unstable; and
rebooting the system according to the corresponding signal.

6. The method according the claim 5, further comprising displaying a rebooting alarm message when the system is rebooted according to the corresponding signal, advising that the system is shut down due to instability of the system.

7. The method according the claim 5, wherein the system is detected to be unstable when the power mode is not set to the power-off mode and the set power mode is performed more than a predetermined number of times.

8. The method according to the claim 5, wherein the system is detected to be unstable when the power mode is not set to the power-off mode and the number of applications that are currently being performed exceeds a predetermined number.
